(19) United States
(12) Patent Application Publication
(10) Pub. No.: US 2025/0263821 A1
(43) Pub. Date: Aug. 21, 2025

(54) NEGATIVE ELECTRODE ACTIVE MATERIAL AND PRODUCTION METHOD THEREFOR

(71) Applicants: TOYOTA JIDOSHA KABUSHIKI KAISHA, Toyota-shi (JP); AICHI STEEL CORPORATION, Tokai-shi (JP); JAPAN METALS AND CHEMICALS CO., LTD., Tokyo (JP)

(72) Inventors: Makio KON, Toyota-shi (JP); Hiroyuki KAIYA, Toyota-shi (JP); Masanobu OUCHI, Nagoya-shi (JP); Tomoya MATSUNAGA, Susono-shi (JP); Hiroshi SUYAMA, Mishima-shi (JP); Shigeki SATO, Fujinomiya-shi (JP); Yusaku INATOMI, Susono-shi (JP); Takashi SAZUKA, Fuji-shi (JP); Hiroshi MIYAKAWA, Susono-shi (JP); Akihiro MATSUYAMA, Tokai-shi (JP); Takao SAWA, Nishiokitama-gun (JP); Katsuyuki KUDO, Nishiokitama-gun (JP); Tomoki SOUMA, Nishiokitama-gun (JP)

(73) Assignees: TOYOTA JIDOSHA KABUSHIKI KAISHA, Toyota-shi (JP); AICHI STEEL CORPORATION, Tokai-shi (JP); JAPAN METALS AND CHEMICALS CO., LTD., Tokyo (JP)

(21) Appl. No.: 19/006,513

(22) Filed: Dec. 31, 2024

(30) Foreign Application Priority Data
Feb. 19, 2024 (JP) 2024-022902

(51) Int. Cl. C22F 1/16; B22D 11/00; C22C 30/00; C22F 1/02; H01M 4/38

(52) U.S. Cl. CPC C22C 30/00; B22D 11/001; C22F 1/02; C22F 1/16; H01M 4/383

(57) ABSTRACT

A production method for a negative electrode active material in the present disclosure includes: obtaining a thin piece by cooling molten metal of a hydrogen absorbing alloy containing Ti, Zr, Cr, Mn, and Ni, at a speed of 1×10²° C./second to 1×10⁴° C./second, at least to lower than 500° C.; and performing heat treatment of the thin piece at 500° C. to 900° C. for 1 hour to 10 hours in a vacuum or an inert gas atmosphere. The negative electrode active material obtained by the production method includes hydrogen absorbing alloy including a plurality of main phases and a grain boundary phase that exists between mutually adjacent main phases of the main phases, each of the main phases include an AB₂ alloy phase, the grain boundary phase includes an AB alloy phase, and the average distance between the mutually adjacent main phases is 1.0 μm or less.

### CROSS-REFERENCE TO RELATED APPLICATION

This application claims priority to Japanese Patent Application No. 2024-022902 filed on Feb. 19, 2024. The disclosure of the above-identified application, including the specification, drawings, and claims, is incorporated by reference herein in its entirety.

### BACKGROUND

### 1. Technical Field

The present disclosure relates to a negative electrode active material and a production method therefor.

### 2. Description of Related Art

A hydrogen absorbing alloy is used as a negative electrode active material of a nickel-hydrogen battery. As the hydrogen absorbing alloy, an AB₅ alloy (for example, an La(NiCoMnAl)₅ alloy) and an A₂B₇ alloy (for example, an (LaSmMg)₂(NiAl)₇ alloy) are known. Each of the AB₅ alloy and the A₂B₇ alloy needs a rare earth element, and therefore, has a high resource risk. Further, the AB₅ alloy sometimes needs to contain a large amount of Co, which is expensive.

Hence, Japanese Unexamined Patent Application Publication No. 10-36930 (JP 10-36930 A) discloses a hydrogen absorbing alloy that does not contain the rare earth element and that does not need to contain a large amount of an expensive element such as Co. The hydrogen absorbing alloy disclosed in JP 10-36930 A contains predetermined amounts of Zr, Ti, Nb, V, Ni, Mn, Cr, Co, Fe, Si, Mo, and B, and includes an intermetallic compound as an alloy phase, and the intermetallic compound is a C15-type or C14-type cubic crystal that belongs to a Laves phase.

### SUMMARY

When the hydrogen absorbing alloy disclosed in JP 10-36930 A is used as the negative electrode active material, the rare earth element is not used, and the use amount of the expensive element is small, but the discharge capacity sometimes becomes insufficient. Therefore, the inventors have found that there is a problem in that a negative electrode active material that makes it possible to improve the discharge capacity at a low resource risk and a low cost and a production method therefor have been demanded.

The present disclosure has been made for solving the above problem, and has an object to provide a negative electrode active material that makes it possible to improve the discharge capacity at a low resource risk and a low cost and a production method therefor.

The inventors have performed keen examination for achieving the above object, and have completed a negative electrode active material and a production method therefor in the present disclosure. Aspects thereof are shown as follows.

### <Aspect 1>

A production method for a negative electrode active material, comprising:
obtaining a thin piece by cooling molten metal of a hydrogen absorbing alloy containing Ti, Zr, Cr, Mn, and Ni, at a speed of 1×10²° C./second to 1×10⁴° C./second, at least to lower than 500° C.; and
performing heat treatment of the thin piece at 500° C. to 900° C. for 1 hour to 10 hours in a vacuum or an inert gas atmosphere.

### <Aspect 2>

The production method for the negative electrode active material according to aspect 1, wherein one or more elements selected from the group consisting of Fe, Co, V, Nb, Mo, B, Mg, and Al are substituted for some of Ti, Zr, Cr, Mn, and Ni.

### <Aspect 3>

The production method for the negative electrode active material according to aspect 1 or 2, wherein the molten metal is cooled using a strip cast method.

### <Aspect 4>

A negative electrode active material comprising a hydrogen absorbing alloy containing Ti, Zr, Cr, Mn, and Ni, wherein:
the hydrogen absorbing alloy includes a plurality of main phases and a grain boundary phase that exists between mutually adjacent main phases of the main phases;
each of the main phases includes an AB₂ alloy phase, and the grain boundary phase includes an AB alloy phase;
in the AB₂ alloy phase, A is one or more elements selected from the group consisting of Ti and Zr, and B is one or more elements selected from the group consisting of Cr, Mn, and Ni;
in the AB alloy phase, A is one or more elements selected from the group consisting of Ti and Zr, and B is Ni; and
an average distance between the mutually adjacent main phases is 1.0 μm or less.

### <Aspect 5>

The negative electrode active material according to aspect 4, wherein one or more elements selected from the group consisting of Fe, Co, V, Nb, Mo, B, Mg, and Al are substituted for some of Ti, Zr, Cr, Mn, and Ni.

In the present disclosure, the molten metal of the hydrogen absorbing alloy containing Ti, Zr, Cr, Mn, and Ni is rapidly cooled, and thereby, a thin piece that includes the plurality of main phases and the grain boundary phase existing between the mutually adjacent main phases and in which the main phases and the grain boundary phase are refined is obtained. By performing the heat treatment of the thin piece under a predetermined condition, the grain boundary phase is reformed, and a hydrogen absorbing alloy in which the value of the average distance between mutually adjacent main phases is in a predetermined range is obtained. Moreover, by using this hydrogen absorbing alloy, it is possible to provide a negative electrode active material in which the discharge capacity is improved and a production method therefor, at a low resource risk and a low cost.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a SEM image of a sample in an example 1;

FIG. 1B is a distribution diagram about FIG. 1A in which the region of an AB₂ alloy phase (main phase) is shown in black and the region of an AB alloy phase (grain boundary phase) is shown in white;

FIG. 2A is a SEM image of a sample in a reference example 1;

FIG. 2B is a distribution diagram about FIG. 2A in which the region of the AB₂ alloy phase (main phase) is shown in black and the region of the AB alloy phase (grain boundary phase) is shown in white;

FIG. 3 is a graph showing XRD analysis results about respective samples in the example 1, an example 2, a comparative example 1, and the reference example 1; and

FIG. 4 is a graph showing relations between current densities and discharge capacities about the respective samples in the example 1, the example 2, the comparative example 1, and the reference example 1.

### DETAILED DESCRIPTION OF EMBODIMENTS

An embodiment of a negative electrode active material and a production method therefor in the present disclosure will be described below in detail. Note that the embodiment shown below does not limit the negative electrode active material and the production method therefor in the present disclosure.

Although not constrained by theories, the knowledge obtained by the inventors about the reason why the negative electrode active material in the present disclosure makes it possible to improve the discharge capacity at a low resource risk and a low cost will be described.

As a hydrogen absorbing alloy that does not contain a rare earth element and that does not need to contain a large amount of an expensive element such as Co, there is an alloy that contains Ti, Zr, Cr, Mn, and Ni. When the molten metal having the composition of this alloy is solidified by being cooled at an ordinary speed, a two-phase hydrogen absorbing alloy that includes an AB₂ alloy phase having a Laves structure and an AB alloy phase having CsCl crystal structure is obtained. Moreover, since the molten metal is cooled at an ordinary speed, each of the AB₂ alloy phase and the AB alloy phase is coarse. Note that, in the present specification, unless otherwise particularly noted, “cooling the molten metal at an ordinary speed” means, for example, a case where the molten metal is obtained by the arc melting of raw materials charged in a crucible and is cooled within the same crucible.

In the two-phase hydrogen absorbing alloy, the AB₂ alloy phase constitutes a main phase that mainly bears hydrogen absorption, and the AB alloy phase constitutes a grain boundary phase that mainly bears charge-discharge activity. The two-phase hydrogen absorbing alloy includes a plurality of main phases and a grain boundary phase that exists between mutually adjacent main phases.

For securing a sufficient discharge capacity in the two-phase hydrogen absorbing alloy, it is necessary to sufficiently secure the volume fraction of the AB₂ alloy phase that constitutes the main phase. Therefore, it is preferable that the volume fraction of the AB alloy phase that constitutes the grain boundary phase is up to about 30%. Further, in the case where the molten metal is cooled at an ordinary speed, the AB alloy phase that constitutes the grain boundary phase segregates.

For sufficiently obtaining the charge-discharge activity even in the case where the volume fraction of the AB alloy phase that constitutes the grain boundary phase is small, that is, even in the case where the amount of the AB alloy phase that constitutes the grain boundary phase is small, it is effective to refine the texture of the two-phase hydrogen absorbing alloy by rapidly cooling the molten metal. Thereby, the dispersion degree of the AB alloy phase that constitutes the grain boundary phase is enhanced. Moreover, by performing the heat treatment of the two-phase hydrogen absorbing alloy having the refined texture under a predetermined condition, the AB alloy phase that constitutes the grain boundary phase is reformed, and the crystalline is decreased, so that there is an advantage in that the charge-discharge activity is enhanced. This is thought to be because the decrease in crystalline promotes the diffusion of hydrogen.

Further, when the texture of the two-phase hydrogen absorbing alloy is refined, the distance between the mutually adjacent main phases is shortened, and furthermore, when the grain boundary phase is reformed, the distance between the mutually adjacent main phases is further shortened. Since the grain boundary phase exists between the mutually adjacent main phases, the shortening of the distance between the mutually adjacent main phases means that the grain boundary phase sandwiched between the mutually adjacent main phases becomes thin. The inventors have known that the discharge capacity can be improved when the two-phase hydrogen absorbing alloy having such a texture is used as the negative electrode active material.

The production method for the negative electrode active material in the present disclosure based on the above-described knowledge, and constituent elements of the negative electrode active material in the present disclosure that is obtained by the production method will be described below.

### Production Method for Negative Electrode Active Material

The production method for the negative electrode active material in the present disclosure (also referred to as merely “the production method in the present disclosure” hereinafter) includes rapid molten metal cooling and heat treatment. The rapid molten metal cooling and the heat treatment will be described below.

### Rapid Molten Metal Cooling

In the production method in the present disclosure, a thin piece is obtained by cooling the molten metal of a hydrogen absorbing alloy containing titanium (Ti), zirconium (Zr), chromium (Cr), manganese (Mn), and nickel (Ni), at a speed of 1×10²° C./second to 1×10⁴° C./second, at least to lower than 500° C.

The molten metal only needs to contain Ti, Zr, Cr, Mn, and Ni, and to have a component composition that forms a hydrogen absorbing alloy after the solidification of the molten metal. For example, the content ratios of Ti, Zr, Cr, Mn, and Ni may be the following content ratios.

The content ratios of Ti, Zr, Cr, and Mn in the molten metal each may be 10 atom % or more, 12 atom % or more, 15 atom % or more, or 18 atom % or more with respect to the whole molten metal, and may be 50 atom % or less, 45 atom % or less, 40 atom % or less, 35 atom % or less, 30 atom % or less, 28 atom % or less, 26 atom % or less, 24 atom % or less, 22 atom % or less, or 20 atom % or less. In order that the volume fraction of the AB alloy phase that constitutes the grain boundary phase is up to about 30%, it is preferable that each of the content ratios of Ti, Zr, Cr, and Mn in the molten metal is 12 atom % to 24 atom % with respect to the whole molten metal.

The content ratio of Ni in the molten metal may be 15 atom % or more, 20 atom % or more, 22 atom % or more, 24 atom % or more, or 25 atom % or more with respect to the whole molten metal, and may be 60 atom % or less, 55 atom % or less, 50 atom % or less, 45 atom % or less, 40 atom % or less, 38 atom % or less, 36 atom % or less, 34 atom % or less, 32 atom % or less, 30 atom % or less, 28 atom % or less, or 26 atom % or less. In order that the volume fraction of the AB alloy phase that constitutes the grain boundary phase is up to about 30%, it is preferable that the content ratio of Ni in the molten metal is 20 atom % to 30 atom % with respect to the whole molten metal.

One or more elements selected from the group consisting of iron (Fe), cobalt (Co), vanadium (V), niobium (Nb), molybdenum (Mo), boron (B), magnesium (Mg), and aluminum (Al) may be substituted for some of Ti, Zr, Cr, Mn, and Ni in the molten metal. It is preferable that the total of the respective content ratios of Fe, Co, V, Nb, Mo, B, Mg, and Al is 50 atom % or less, 45 atom % or less, 40 atom % or less, 35 atom % or less, 30 atom % or less, 25 atom % or less, 20 atom % or less, 15 atom % or less, 10 atom % or less, 5 atom % or less, or 0 atom % with respect to the whole molten metal. When the total of the respective content ratios of Fc, Co, V, Nb, Mo, B, Mg, and Al is one of the above-described ratios with respect to the whole molten metal, a practical adverse influence is not exerted on the production method in the present disclosure and the product by the production method. The case where the total of the content ratios is 0 atom % means that one or more elements selected from the group consisting of Fe, Co, V, Nb, Mo, B, Mg, and Al are not substituted for some of Ti, Zr, Cr, Mn, and Ni in the molten metal.

The molten metal can contain an element other than Ti, Zr, Cr, Mn, Ni, Fe, Co, V, Nb, Mo, B, Mg, and Al, as long as a practical adverse influence is not exerted on the production method in the present disclosure and the product by the production method. It is preferable that the content ratio of the other element is 8 atom % or less, 6 atom % or less, 4 atom % or less, 2 atom % or less, or 0 atom % with respect to the whole molten metal. In the case where there is a plurality of other elements, the total of the content ratios of the other elements satisfies the above requirement. The case where the content ratio is 0 atom % means that the molten metal does not contain the element other than Ti, Zr, Cr, Mn, Ni, Fe, Co, V, Nb, Mo, B, Mg, and Al. The element other than Ti, Zr, Cr, Mn, Ni, Fe, Co, V, Nb, Mo, B, Mg, and Al is typically an irreversible impurity.

That is, the molten metal contains Ti, Zr, Cr, Mn, and Ni. Optionally, one or more elements selected from the group consisting of Fe, Co, V, Nb, Mo, B, Mg, and Al may be substituted for some of Ti, Zr, Cr, Mn, and Ni, and the remnant may be an irreversible impurity. In the present specification, unless otherwise particularly noted, the irreversible impurity is a substance that cannot be avoided from being contained or requires a significant rise in production cost for the avoidance, as exemplified by an impurity that is contained in raw materials or an impurity that is mixed during the production process.

The above-described molten metal is cooled at a speed of 1×10²° C./second to 1×10⁴° C./second, at least to lower than 500° C.

When the molten metal is cooled at a speed of 1×10²° C./second or higher, a hydrogen absorbing alloy having a refined texture is obtained. From this standpoint, the cooling speed of the molten metal may be 5×10²° C./second or higher, 7×10²° C./second or higher, 9×10²° C./second or higher, or 1×10³° C./second or higher. When the molten metal is cooled at a speed of 1×10⁴° C./second or lower, the molten metal is needlessly cooled at a high speed despite the saturation of the refinement of the texture. From this standpoint, the cooling speed of the molten metal may be 9×10³° C./second or lower, 7×10³° C./second or lower, 5×10³° C./second or lower, or 3×10³° C./second or lower.

At the above-described speed, the molten metal is cooled at least to lower than 500° C. Thereby, after the solidification of the molten metal is started, it is possible to restrain the crystal growth of the AB₂ alloy phase that constitutes the main phase and the AB alloy phase that constitutes the grain boundary phase, and it is possible to restrain the coarsening of the alloy phases. From this standpoint, at the above-described speed, the molten metal may be cooled at least to 480° C. or lower, 460° C. or lower, 440° C. or lower, 420° C. or lower, or 400° C. or lower.

The cooling method for the molten metal is not particularly limited, as long as the thin piece can be obtained by cooling the molten metal under the above-described condition. The molten metal is typically cooled using a strip cast method.

The strip cast method will be briefly described. Raw materials are molten in a melting furnace, and the molten metal having the above-described composition is prepared. Then, the molten metal is supplied in a tundish. The molten metal supplied in the tundish is supplied by the self-weight from an end portion of the tundish to a surface of a cooling drum. The molten metal is cooled on an outer circumference of a cooling roll that is rotating, and thereby, the molten metal is solidified and becomes a thin piece. Then, the thin piece is retrieved.

In consideration of the material of the cooling roll, and the like, the circumferential velocity of the cooling roll may be appropriately decided such that the cooling speed of the molten metal is in a desired range. The circumferential velocity of the cooling roll, which is the surface velocity of the cooling roll, may be 0.1 m/second or higher, 0.5 m/second or higher, 1.0 m/second or higher, 1.5 m/second or higher, or 2.0 m/second or higher, and may be 10.0 m/second or lower, 7.0 m/second or lower, 4.0 m/second or lower, 3.5 m/second or lower, or 3.0 m/second or lower.

From the standpoint of the prevention of the oxidation of the molten metal and the thin piece, it is preferable that the molten metal is cooled in an inert gas atmosphere, particularly, in an argon gas atmosphere. The inert gas atmosphere includes also a nitrogen gas atmosphere.

### Heat Treatment

The heat treatment of the thin piece obtained by the rapid molten metal cooling is performed at 500° C. to 900° C. for 1 hour to 10 hours in a vacuum or an inert gas atmosphere.

When the heat treatment temperature is 500° C. or higher, it is possible to reform the AB alloy phase that constitutes the grain boundary phase. From this standpoint, the heat treatment temperature may be 550° C. or higher, 600° C. or higher, or 650° C. or higher. When the heat treatment temperature is 900° C. or lower, the coarsening of the AB₂ alloy phase that constitutes the main phase and the AB alloy phase that constitutes the grain boundary phase is avoided. From this standpoint, the heat treatment temperature may be 850° C. or lower, 800° C. or lower, 750° C. or lower, or 700° C. or lower.

The heat treatment time is decided such that the AB alloy phase that constitutes the grain boundary phase is reformed, in consideration of the heat treatment temperature and the like. When the heat treatment time is 1 hour or more, it is possible to practically recognize the reformation of the AB alloy phase that constitutes the grain boundary phase. From this standpoint, the heat treatment time may be 1.5 hours or more, 2 hours or more, or 2.5 hours or more. When the heat treatment hour is 10 hours or less, the coarsening of the AB₂ alloy phase that constitutes the main phase and the AB alloy phase that constitutes the grain boundary phase is avoided. From this standpoint, the heat treatment time may be 9 hours or less, 8 hours or less, 7 hours or less, 6 hours or less, 5 hours or less, 4 hours or less, or 3 hours or less.

For restraining the oxidation of the thin piece, the heat treatment of the thin piece is performed in a vacuum or an inert gas atmosphere. In the case where the heat treatment is performed in a vacuum, the absolute pressure of the atmosphere may be 1×10⁻⁷ Pa or higher, 1×10⁻⁶ Pa or higher, or 1×10⁻⁵ Pa or higher, and may be 1×10⁻² Pa or lower, 1×10⁻³ Pa or lower, or 1×10⁻⁴ Pa or lower. The inert gas atmosphere is typically an argon gas atmosphere. For the inert gas atmosphere, a Group 18 element such as argon is recommended.

### Negative Electrode Active Material

The negative electrode active material in the present disclosure is the product by the production method in the present disclosure. The component composition and texture of the negative electrode active material in the present disclosure will be described below.

### Component Composition

The negative electrode active material obtained by the production method in the present disclosure includes a hydrogen absorbing alloy containing Ti, Zr, Cr, Mn, and Ni. Moreover, one or more elements selected from the group consisting of Fe, Co, V, Nb, Mo, B, Mg, and Al may be substituted for some of Ti, Zr, Cr, Mn, and Ni.

The component composition range of the hydrogen absorbing alloy is basically the same as the component composition range of the molten metal described in “Production Method for Negative Electrode Active Material”. However, in the case where the component composition changes due to the natural decrease in a particular element, or the like, in the middle of the production process, or the like, the change in the component composition may be previously considered, such that the component composition range of the molten metal is the same as the component composition range of the hydrogen absorbing alloy, when raw materials are molten. In the description in “Production Method for Negative Electrode Active Material”, “the whole molten metal” is replaced with “the whole hydrogen absorbing alloy”.

### Texture

The hydrogen absorbing alloy that is used in the negative electrode active material in the present disclosure includes a plurality of main phases and a grain boundary phase that exists between mutually adjacent main phases. The main phase mainly has a hydrogen absorbing function. The grain boundary phase mainly has a charge-discharge activity function. Since the grain boundary phase exists between mutually adjacent main phases, the movement of the hydrogen absorbed in the main phase is promoted, and the charge and discharge of the battery is activated.

The main phase includes the AB₂ alloy phase. The “AB₂ alloy phase” means an alloy phase of 1 mol of an “A” element and 2 mol of a “B” element. A is one or more elements selected from the group consisting of titanium (Ti) and zirconium (Zr), and B is one or more elements selected from the group consisting of chromium (Cr), manganese (Mn), and nickel (Ni). The form of the alloy phase is typically an intermetallic compound, but without being limited to this, for example, one of A and B is solved in the other of A and B, at a part or whole of the alloy phase.

The grain boundary phase includes the AB alloy phase. The “AB alloy phase” means an alloy phase of 1 mol of an “A” element and 1 mol of a “B” element. A is one or more elements selected from the group consisting of titanium (Ti) and zirconium (Zr), and B is nickel (Ni). The form of the alloy phase is typically an intermetallic compound, but without being limited to this, for example, one of A and B is solved in the other of A and B, at a part or whole of the alloy phase.

In each of the AB₂ alloy phase and the AB alloy phase, one or more elements selected from the group consisting of Fe, Co, V, Nb, Mo, B, Mg, and Al may be substituted for some of the constituent elements.

Note that, each of “AB₂ alloy phase” and “AB alloy phase” conforms to a conventional notation method about the alloy phase in the hydrogen absorbing alloy. However, in the case where there is a possibility of the confusion with boron (element B), “AB₂ alloy phase” and “AB alloy phase” may be expressed, for example, as “ab₂ alloy phase” and “ab alloy phase”, respectively.

The hydrogen absorbing alloy in the negative electrode active material in the present disclosure is a two-phase alloy including the main phase and the grain boundary phase. The grain boundary phase is sandwiched between the main phase and the main phase, and the grain boundary phase exists between the adjacent main phases. By the rapid molten metal cooling, the grain size of the main phase becomes small, and the grain boundary phase becomes thin. By the heat treatment, the grain boundary phase is reformed, and the crystalline decreases. Thereby, the grain boundary phase becomes further thin. Therefore, the change in the texture by the rapid molted metal cooling and the heat treatment can be evaluated based on the thickness of the grain boundary phase.

The texture of the actual hydrogen absorbing alloy has a three-dimensional shape, and when the grain boundary phase is sandwiched between the main phase and the main phase, “the thickness of the grain boundary phase” is easily defined in a three-dimensional space. However, as described later, the thickness of the grain boundary phase is measured using a two-dimensional SEM image. In a two-dimensional space, “the thickness of the grain boundary phase” is not easily defined. “The thickness of the grain boundary phase” in the three-dimensional space corresponds to “the distance between the mutually adjacent main phases” in the two-dimensional space. Further, the measurement is performed at a plurality of spots in the SEM image, and therefore, the change in the texture by the rapid molten metal cooling and the heat treatment is evaluated based on “the average distance between mutually adjacent main phases”.

Next, a specific measurement method for “the average distance between mutually adjacent main phases” will be described.

The hydrogen absorbing alloy is cut and is polished, and the SEM image (backscattered electron image) of the polished surface is obtained. Then, for the SEM image, an EDX surface analysis is performed. In the case where the hydrogen absorbing alloy is powdered by grinding or the like, the SEM image may be obtained by burying the powder in resin and performing polishing. The magnification of the SEM image is 1000 power. The A element and the B element are almost the same in the AB alloy phase, and therefore, the region of the AB alloy phase can be discriminated from the result of the EDX surface analysis. Further, the region of the AB₂ alloy phase is discriminated from the SEM image, using a general-purpose object detection model. Then, from the result of the EDX surface analysis and the discrimination result using the object detection model, the region of the AB₂ alloy phase is defined in black and the region of the AB alloy phase is defined in white.

Thereby, the whole SEM image is expressed as an irregular crosshatch. The region of the AB₂ alloy phase that is expressed in black has a grain form, and the region of the AB alloy phase that is expressed in white has a form in which a plurality of straight lines and/or curve lines is combined. The length of the region of the AB alloy phase that is expressed in white, which is a length in a direction perpendicular to the longitudinal direction of the region of the AB alloy phase, is measured at 20 spots, and the average value of the measured values is adopted as “the average distance between mutually adjacent main phases”.

When the average distance between mutually adjacent main phases is 1.0 μm or less, the refinement of the texture and the reformation of the grain boundary phase are excellent, so that the discharge capacity is enhanced. From this standpoint, the average distance between mutually adjacent main phases may be 0.9 μm or less, 0.8 μm or less, 0.7 μm or less, or 0.6 μm or less. An excessive refinement of the texture decreases the discharge capacity rather, and therefore, it is preferable that the average distance between mutually adjacent main phases is 0.2 μm or more, 0.3 μm or more, or 0.4 μm or more.

### Modification

The negative electrode active material and the production method therefor in the present disclosure can be modified when appropriate, within the scope of the contents described in the claims. For example, the thin piece after the heat treatment may be ground and classified as necessary.

The negative electrode active material and the production method therefor in the present disclosure will be further specifically described below with examples and a comparative example. Note that the negative electrode active material and the production method therefor in the present disclosure are not limited to conditions that are used in the examples described below.

### Preparation of Sample

Samples were prepared in the following way.

### Example 1

The high-frequency melting of a raw material containing 18.6 atom % Ti, 18.6 atom % Zr, 18.6 atom % Cr, 18.6 atom % Mn, and 25.6 atom % Ni was performed, and a thin piece was obtained using the strip cast method. A cooling roll was rotated at a cooling roll surface velocity of 2 m/second, such that the cooling speed of the molten metal was 1×10³° C./second. The high-frequency melting and the strip cast were performed in an argon gas atmosphere. The purities of the raw materials of Ti, Cr, Mn, and Ni were 99.8 mass % or more, and the purity of the raw material of Zr was 98%.

The heat treatment of the thin piece was performed at 900° C. for 2 hours. The heat treatment was performed in a vacuum. The speed of the temperature rising to 900° C. was 5° C./minute. Note that the above-described time of 2 hours is the retention time after the temperature reaches 900° C. Further, after the retention, furnace cooling was performed.

The thin piece after the heat treatment was ground by a manual stamp mill DA-30 manufactured by Tokyo Garasu Kikai Co., Ltd., and the obtained powder was classified into 38 μm to 100 μm, using a 38-μm sieve and a 100-μm sieve.

### Example 2

A sample in an example 2 was prepared similarly to the example 1, except that the heat treatment temperature was 500° C. and the speed of the temperature rising to 500° C. was 5° C./minute. Note that, as a thin piece used for the heat treatment, the thin piece after the high-frequency melting and the strip cast in the preparation of the sample in the example 1 was used.

### Comparative Example 1

A sample in a comparative example 1 was prepared similarly to the example 1, except that the heat treatment of the thin piece was not performed. Note that, as a thin piece used for the heat treatment, the thin piece after the high-frequency melting and the strip cast in the preparation of the sample in the example 1 was used.

### Reference Example 1

A raw material containing 18.6 atom % Ti, 18.6 atom % Zr, 18.6 atom % Cr, 18.6 atom % Mn, and 25.6 atom % Ni was charged in a crucible, and the arc melting of them was performed, so that molten metal was obtained. Thereafter, the molten metal was cooled in the crucible, and the molten metal was solidified, so that an ingot was obtained. The melting and the cooling were repeated in the crucible three times, and thereby, the component composition of the ingot was homogenized. The purities of the raw materials of Ti, Cr, Mn, and Ni were 99.8 mass % or more, and the purity of the raw material of Zr was 98%.

The ingot was ground by a manual stamp mill DA-30 manufactured by Tokyo Garasu Kikai Co., Ltd., and the obtained powder was classified into 38 μm to 100 μm, using a 38-μm sieve and a 100-μm sieve.

### Evaluation

The samples were evaluated as follows.

### Component Composition

The quantitative analysis of the sample in the example 1 and the sample in the reference example 1 was by an ICP. The sample in the example 1 contained 18.51 atom % Ti, 18.06 atom % Zr, 19.45 atom % Cr, 16.94 atom % Mn, and 27.04 atom % Ni. The sample in the reference example 1 contained 19.80 atom % Ti, 17.70 atom % Zr, 18.10 atom % Cr, 17.00 atom % Mn, and 27.40 atom % Ni. For each sample in the example 1 and the reference example 1, it could be confirmed that the change in component composition between the component composition of the raw material and the component composition of the sample is in a range in which there is no practical problem.

### Texture (Average Distance Between Mutually Adjacent Main Phases)

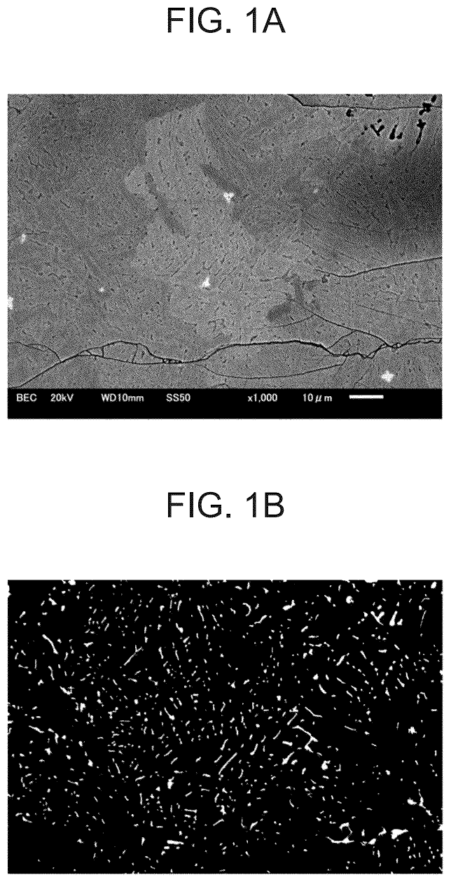

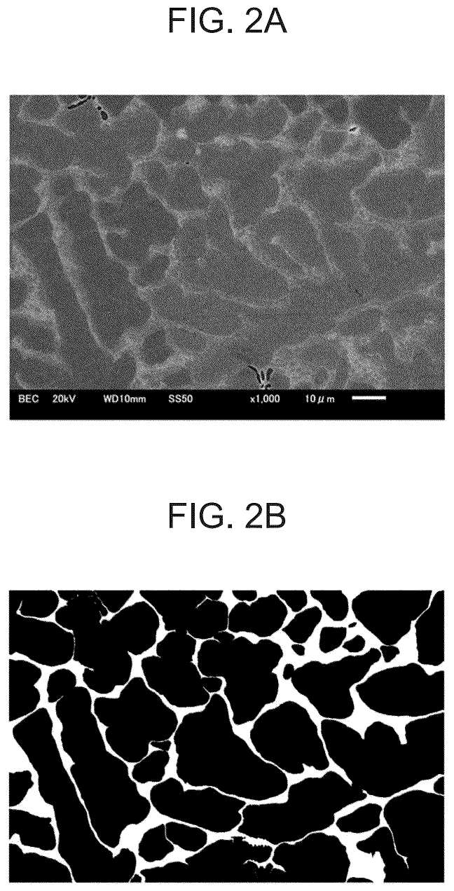

The SEM observation and EDX surface analysis of the sample in the example 1 and the sample in the reference example 1 were performed. Then, the average distance between mutually adjacent main phases was evaluated by the above-described method. FIG. 1A shows the SEM image of the sample in the example 1. FIG. 1B is a distribution diagram about FIG. 1A in which the region of the AB₂ alloy phase (main phase) is shown in black and the region of the AB alloy phase (grain boundary phase) is shown in white. FIG. 2A is the SEM image of the sample in the reference example 1. FIG. 2B is a distribution diagram about FIG. 2A in which the region of the AB₂ alloy phase (main phase) is shown in black and the region of the AB alloy phase (grain boundary phase) is shown in white.

In FIG. 1A, each black point portion shows the AB₂ alloy phase (main phase), and it can be understood that the texture is very refined. The AB alloy phase (grain boundary phase) is smaller than the AB₂ alloy phase (main phase), and therefore, it is thought that all regions of the AB alloy phases (grain boundary phases) are not shown in white in FIG. 1B. That is, it is thought that regions shown in white show relatively large AB alloy phases (grain boundary phases) of all AB alloy phases (grain boundary phases) in FIG. 1B. For the average distance between mutually adjacent main phases, the upper limit is important, and therefore, there is no practical problem, even when the average distance between mutually adjacent main phases is evaluated using FIG. 1B.

In consideration of this, the average distance between mutually adjacent main phases was evaluated by the above-described method. As a result, the average distance between mutually adjacent main phases was 0.6 μm in the sample in the example 1, and was 2.2 μm in the sample in the reference example 1. As for the sample in the example 2, it was further difficult to confirm the region of the AB alloy phase (grain boundary phase), but it was confirmed that the average distance between mutually adjacent main phases was equal to or less than that in the sample in the example 1.

### Crystal Structure

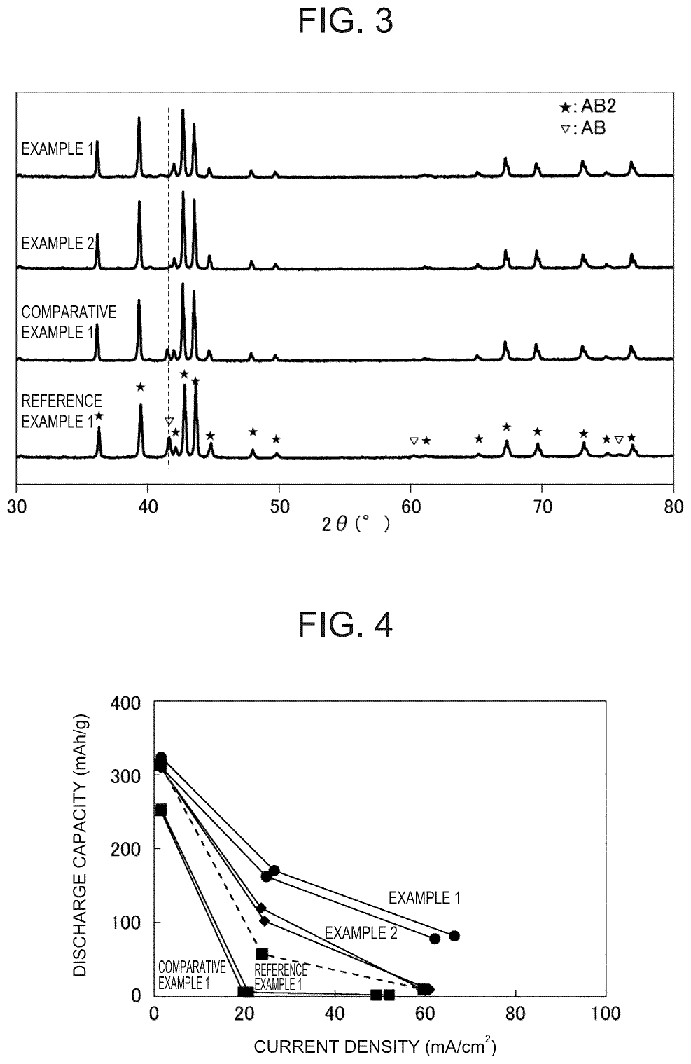

An XRD analysis is performed for each sample in the example 1, the example 2, the comparative example 1, and the reference example 1. The result is shown in FIG. 3. As shown in FIG. 3, in the samples in the examples 1 and 2 (the rapid cooling and the heat treatment were performed), some of peaks for the AB alloy phase (grain boundary phase) were not recognized (see a broken line in FIG. 3). On the other hand, in the comparative example 1 (only the rapid cooling was performed and the heat treatment was not performed), all peaks for the AB alloy phase (grain boundary phase) were recognized. This suggests that the heat treatment decreased the crystalline of the AB alloy phase (grain boundary phase).

### Discharge Characteristic

A cell for evaluation was made as follows.

First, a negative electrode was made. More specifically, 49 mass parts of the above hydrogen absorbing alloy as a negative electrode active material, 49 mass parts of Ni powder as a conductive auxiliary agent, and 2 mass parts of carboxymethylcellulose (CMC) as a binder were kneaded, and thereby, a composition paste was made. The composition paste was loaded in a negative electrode current collector, and then, vacuum drying was at 80° C. Thereafter, roll pressing (clearance: 300 μm) was performed at a pressure of about 8 kN, and thereby, the negative electrode was obtained. Note that, as the negative electrode current collector, a porous nickel (Celmet #7 manufactured by Sumitomo Electric Industries, Ltd., thickness: 1.6 mm) to which a Ni tab was welded was used. Further, the capacity was adjusted so as to become about 240 mAh.

Next, a positive electrode was made. More specifically, 88 mass parts of nickel hydroxide (Ni(OH)₂) as a positive electrode active material, 10 mass parts of cobalt oxide (CoO) as a conductive auxiliary agent, and 2 mass parts of two kinds of binders (1 mass part of carboxymethylcellulose (CMC) and 1 mass part of polyvinyl alcohol (PVA)) were kneaded, and thereby, a composition paste was made. The composition paste was loaded in the above porous nickel, and then, vacuum drying was at 80° C. Thereafter, roll pressing was performed at a pressure of about 8 kN, and thereby, the positive electrode was obtained. Note that the capacity ratio of the negative electrode and the positive electrode was adjusted such that the negative electrode: the positive electrode=1:4.5 was satisfied.

Next, an electrolytic solution was made. Pure water was added to KOH, and the concentration of KOH was adjusted to 6 mol/L, so that 90 ml of the electrolytic solution was obtained. Thereafter, the electrolytic solution and a separator (a PE/PP non-woven fabric, thickness: 150 μm) were disposed in a container, and furthermore, the negative electrode (working electrode), the positive electrode (counter electrode), and an Hg/HgO electrode (reference electrode) were disposed, so that the cell for evaluation was obtained.

Using the obtained cell for evaluation, a charge-discharge test (25° C.) was performed. First, a break-in charge and discharge was performed until the saturation of the negative electrode capacity. More specifically, the charge and discharge were performed as described in the following (1) to (4).
(1) The cell was charged at 0.1 C for 14 hours, and then was discharged at 0.1 C until the negative electrode potential reached −0.6 V.
(2) The cell was charged at 0.5 C for 2.2 hours, and then was discharged at 0.5 C until the negative electrode potential reached −0.6 V.
(3) The cell was charged at 0.1 C for 14 hours, and then was discharged at 0.1 C until the negative electrode potential reached −0.6 V.
(4) The charge and discharge in the above (1) to (3) were repeated until the saturation of the discharge at 0.1 C, and the obtained electrode capacity was adopted as the initial capacity.

After the break-in charge and discharge, the cell for evaluation was charged at 0.2 C for 7.5 hours, and then was discharged at 2 C or 5 C until the negative electrode potential reached −0.5 V. Then, the confirmation of the capacity was performed.

The result is shown in FIG. 4. For each sample (except the reference example 1), there are two results because the test was performed twice under the same condition. From FIG. 4, it can be understood that the samples in the examples 1 and 2 had discharge capacities equal to or higher than that of the sample in the reference example 1 (the molten metal containing the rare earth element was cooled at an ordinary speed). On the other hand, it can be understood that the discharge capacity significantly decreased in the sample in the comparative example 1 (only the rapid cooling was performed and the heat treatment was not performed).

What is claimed is:

1. A production method for a negative electrode active material, comprising:
obtaining a thin piece by cooling molten metal of a hydrogen absorbing alloy containing Ti, Zr, Cr, Mn, and Ni, at a speed of 1×10²° C./second to 1×10⁴° C./second, at least to lower than 500° C.; and
performing heat treatment of the thin piece at 500° C. to 900° C. for 1 hour to 10 hours in a vacuum or an inert gas atmosphere.

2. The production method for the negative electrode active material according to claim 1, wherein one or more elements selected from the group consisting of Fe, Co, V, Nb, Mo, B, Mg, and Al are substituted for some of Ti, Zr, Cr, Mn, and Ni.

3. The production method for the negative electrode active material according to claim 1, wherein the molten metal is cooled using a strip cast method.

4. A negative electrode active material comprising a hydrogen absorbing alloy containing Ti, Zr, Cr, Mn, and Ni, wherein:
the hydrogen absorbing alloy includes a plurality of main phases and a grain boundary phase that exists between mutually adjacent main phases of the main phases;
each of the main phases includes an AB₂ alloy phase, and the grain boundary phase includes an AB alloy phase;
in the AB₂ alloy phase, A is one or more elements selected from the group consisting of Ti and Zr, and B is one or more elements selected from the group consisting of Cr, Mn, and Ni;
in the AB alloy phase, A is one or more elements selected from the group consisting of Ti and Zr, and B is Ni; and
an average distance between the mutually adjacent main phases is 1.0 μm or less.

5. The negative electrode active material according to claim 4, wherein one or more elements selected from the group consisting of Fe, Co, V, Nb, Mo, B, Mg, and Al are substituted for some of Ti, Zr, Cr, Mn, and Ni.
